(19) United States
(12) Patent Application Publication
(10) Pub. No.: US 2015/0301407 A1
(43) Pub. Date: Oct. 22, 2015

(54) Display Panel with Reduced Short-Wavelength Blue Light

(71) Applicant: Top Victory Investments Ltd., Kowloon (HK)

(72) Inventors: Shu-Chen Chan, New Taipei City (TW); Jyh-Cherng Yu, New Taipei City (TW); Hsin-Wei Lin, New Taipei City (TW); Shih-Chun Tseng, New Taipei City (TW); Ming-Li Chang, New Taipei City (TW)

(73) Assignee: Top Victory Investments Ltd., Kowloon (HK)

(21) Appl. No.: 14/254,962

(22) Filed: Apr. 17, 2014

(51) Int. Cl. G02F 1/1335; F21V 8/00

(52) U.S. Cl. CPC G02F 1/133617; G02F 1/133603; G02F 1/133606; G02F 1/133605; G02F 1/133609; G02B 6/0073; G02B 6/0051; G02B 6/005; G02B 6/0026

(57) ABSTRACT

A display panel with reduced short-wavelength blue light is provided and includes a backlight module and an LCD panel. The backlight module includes a plurality of LEDs, each of which includes a blue LED die configured to emit blue light with a peak wavelength ranging from 455 to 475 nm. The present invention may efficiently reduce blue light with wavelengths less than 455 nm to protect eyes, and may not reduce display brightness and encounter color aberration. Moreover, the backlight module may further include an optical filter sheet or film configured to filter blue light with wavelengths less than 455 nm, and may further reduce blue light with wavelengths less than 455 nm to protect eyes more while modulating reduced display brightness and reduce color aberration.

### BACKGROUND OF THE INVENTION

1. Field of the Invention

The present invention relates to a display panel and, more particularly, to a display panel with reduced short-wavelength blue light.

As used within in this disclosure, the term “blue light” generally refers to light with a wavelength ranging from 380 nanometer (nm) to 490 nm, that is to say, including blue light and purple light in traditional meanings. More strictly speaking, light with a wavelength ranging from 380 to 410 nm refers to high-energy blue-purple light, light with a wavelength ranging from 410 to 450 nm refers to “short-wavelength blue light”, and light with a wavelength ranging from 450 to 490 nm refers to long-wavelength blue light.

2. Description of the Related Art

Light-emitting diodes (LEDs) have advantages of lower energy consumption, longer lifetime, faster switching, smaller size and mercury free, and have gradually become the mainstream artificial light source with power saving and carbon reduction. In prior art, the most common white LED uses a blue LED die and a yellow phosphor, which has the maturest technology and low cost. The yellow phosphor absorbs a portion of blue light emitted from the blue LED die and is excited to emit yellow light. The yellow light are then mixed with another portion of blue light emitted from the blue LED die to generate two-wavelength white light. The prior white LED usually uses a blue LED die with a peak wavelength of 444 nm due to higher external quantum efficiency.

Referring to FIG. 1, there is provided a schematic diagram showing a spectrum of a prior white LED. The spectrum of the white LED has two peaks P1 and P2 at two wavelengths of 444 nm and 550 nm respectively. The peak P1 with a stronger intensity is generated by the blue LED die with a peak wavelength of 444 nm, and the peak P2 is generated by the yellow phosphor.

It is well known that long-term exposure to ultraviolet (UV) light can cause damage to human skin and eyes, and may lead to cataract; therefore, many anti-UV-light products have come out. In recent years, medical studies confirm that long-term exposure to blue light with a wavelength ranging from 380 to 490 nm can also cause damage to eyes, and may lead to, for example, macular degeneration of the retina. White LEDs, especially, have been now widely used; however, two-wavelength white light generated by white LEDs have stronger intensity in blue light so that long-term use can cause some degree of damage to eyes. Therefore, many products related to eye protection and anti-blue light have come out in recent years, for example, anti-blue-light cover glasses or protection films adapted to display devices, and anti-blue-light eyeglasses worn by humans. These anti-blue-light products use materials capable of absorbing or reflecting blue light to realize the anti-blue-light function.

Referring to FIG. 2, there is provided a schematic diagram showing a characteristic curve of a prior anti-UV/blue-light protection film. The protection film has average transmittances of about 10% and 37% for UV light at wavelengths ranging from 280 to 320 nm and from 320 to 380 nm respectively, an average transmittance of about 62% for blue light at wavelengths ranging from 380 to 450 nm, and an average transmittance of about 90% for visible light at wavelengths larger than 450 nm. When a display device uses the protection film, its display brightness will be reduced because transmittances at all wavelengths are not up to 100%; moreover, different transmittances at different wavelengths result in some degree of color aberration.

More recently, in August 2013, Emilie Arnault et al. published an article entitled “Phototoxic Action Spectrum on a Retinal Pigment Epithelium Model of Age-Related Macular Degeneration Exposed to Sunlight Normalized Conditions” in PLoS ONE. In this article, it was confirmed that: after light exposure, a photosensitizer, N-retinylidene-N-retinylethanolamine (A2E), may be induced in the region of retinal pigment epithelium (RPE); and after light exposure to the retinal cells with A2E for a period of time, cell viability was decreased while cell necrosis and apoptosis were increased, in which the loss of cell viability was maximal for blue light with wavelengths ranging from 415 to 455 nm. It is noted that the blue light with wavelengths ranging from 415 to 455 nm belongs to short-wavelength blue light.

### SUMMARY OF THE INVENTION

The present invention is adapted to providing a display panel with reduced short-wavelength blue light, which may efficiently reduce blue light with wavelengths less than 455 nm.

According to an aspect of the present invention, there is provided a display panel with reduced short-wavelength blue light, including a backlight module and a liquid-crystal display (LCD) panel. The backlight module includes a plurality of LEDs. Each of the LEDs includes a blue LED die configured to emit blue light with a peak wavelength ranging from 455 to 475 nm.

According to another aspect of the present invention, each of the LEDs may further include a phosphor layer. The phosphor layer is formed around the blue LED die and configured to be excited to emit light to mix with the blue light emitted from the blue LED die to generate specific light.

According to another aspect of the present invention, the backlight module may include a direct-lit backlight module or an edge-lit backlight module.

According to another aspect of the present invention, the direct-lit backlight module further includes a reflector and a diffuser. The reflector is disposed under the LEDs and configured to reflect light emitted from the LEDs. The diffuser is disposed on the LEDs and configured to diffuse the light emitted from the LEDs and light reflected from the reflector. The LCD panel is disposed on the diffuser and configured to display images.

According to another aspect of the present invention, the direct-lit backlight module may further include an optical filter sheet. The optical filter sheet is disposed between the LEDs and the diffuser, or between the diffuser and the LCD panel, or on the LCD panel, and configured to filter blue light with wavelengths less than 455 nm.

According to another aspect of the present invention, the direct-lit backlight module may further include an optical filter film. The optical filter film is disposed on each of the LEDs, or on the diffuser, or on the LCD panel, and configured to filter blue light with wavelengths less than 455 nm.

According to another aspect of the present invention, the edge-lit backlight module further includes a light guide plate and a diffuser. The LEDs are disposed at a side of the light guide plate. The light guide plate is configured to guide the light emitted from the LEDs toward the diffuser. The diffuser is disposed on the light guide plate and configured to diffuse light outputted from the light guide plate. The LCD panel is disposed on the diffuser and configured to display images.

According to another aspect of the present invention, the edge-lit backlight module may further include an optical filter sheet. The optical filter sheet is disposed between the LEDs and the side of the light guide plate, or between the light guide plate and the diffuser, or between the diffuser and the LCD panel, or on the LCD panel, and configured to filter blue light with wavelengths less than 455 nm.

According to another aspect of the present invention, the edge-lit backlight module may further include an optical filter film. The optical filter film is disposed on each of the LEDs, or on the side of the light guide plate corresponding to the LEDs, or on another side of the light guide plate corresponding to the diffuser, or on the diffuser, or on the LCD panel, and configured to filter blue light with wavelengths less than 455 nm.

It is remarked that the above mentioned aspects or features can also be combined with each other and are in the scope of the present invention as well.

By applying the LED with the blue LED die configured to emit blue light with a peak wavelength ranging from 455 to 475 nm, the present invention may efficiently reduce blue light with wavelengths less than 455 nm to prevent blue light with wavelengths ranging from 415 to 455 nm (i.e. short-wavelength blue light) from causing damage to retinal cells to protect eyes. In this case, the present invention may not use materials capable of absorbing or reflecting blue light to realize the anti-blue-light function, and therefore may not reduce display brightness and encounter color aberration.

Moreover, by further using an optical filter sheet or film made of materials capable of absorbing or reflecting blue light to filter blue light with wavelengths less than 455 nm, the present invention may further reduce blue light with wavelengths less than 455 nm while not blocking blue light with wavelengths larger than 455 nm too much, and therefore may modulate reduced display brightness and reduce color aberration.

### BRIEF DESCRIPTION OF THE DRAWINGS

The present invention will be described in further detail below under reference to the accompanying drawings, in which:

FIG. 1 is a schematic diagram showing a spectrum of a prior white LED;

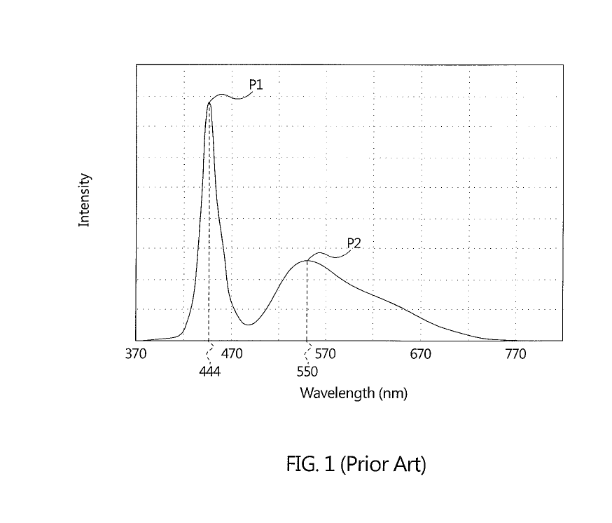

FIG. 2 is a schematic diagram showing a characteristic curve of a prior anti-UV/blue-light protection film;

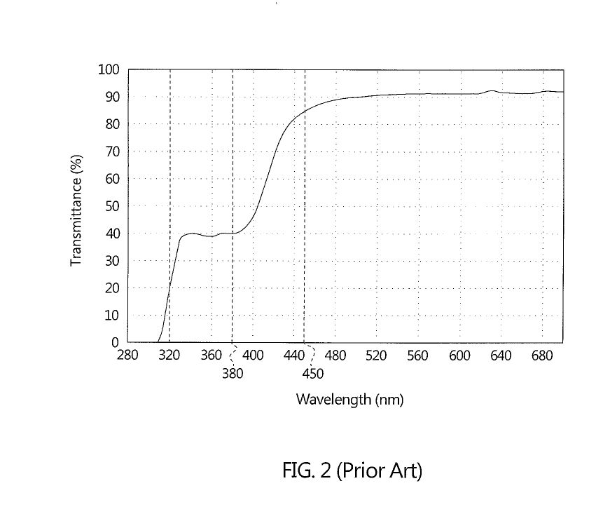

FIG. 3 is a schematic diagram showing a perspective view of a display panel using a direct-lit backlight module according to an exemplary embodiment of the present invention;

FIG. 4 is a schematic diagram showing a cross-sectional view of a white LED according to an exemplary embodiment of the present invention;

FIG. 5 is a schematic diagram showing a spectrum of a white LED according to an exemplary embodiment of the present invention;

FIG. 6 is a schematic diagram showing a spectrum of a white LED according to another exemplary embodiment of the present invention; and

FIG. 7 is a schematic diagram showing a perspective view of a display panel using an edge-lit backlight module according to an exemplary embodiment of the present invention.

### DETAILED DESCRIPTION OF THE INVENTION

Reference will now be made in detail to several embodiments of the present invention that are illustrated in the accompanying drawings. Wherever possible, same or similar reference numerals are used in the drawings and the description to refer to the same or like parts. The drawings are in simplified form and are not to precise scale or shape. For purposes of convenience and clarity only, directional terms, such as up, down, top, bottom, on, and under may be used with respect to the drawings. These and similar directional terms should not be construed to limit the scope of the present invention in any manner.

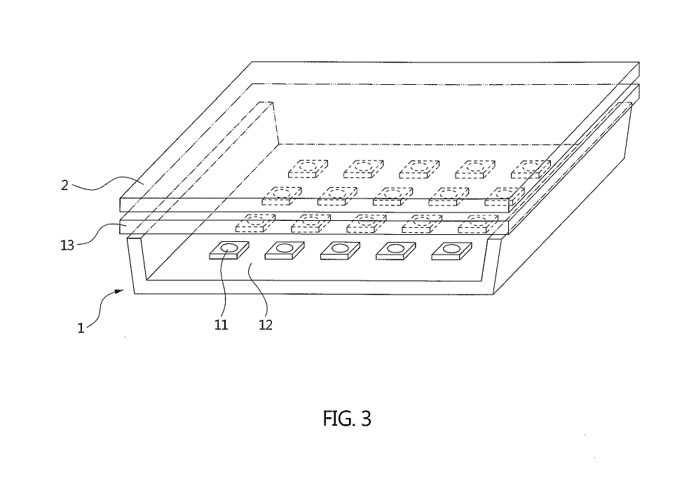

Referring to FIG. 3, there is provided a schematic diagram showing a perspective view of a display panel using a direct-lit backlight module according to an exemplary embodiment of the present invention. The display panel of this embodiment includes a direct-lit backlight module 1 and an LCD panel 2. The direct-lit backlight module 1 includes a plurality of LEDs 11, a reflector 12 and a diffuser 13. The reflector 12 is disposed under the LEDs 11 and configured to reflect light emitted from the LEDs 11. The diffuser 13 is disposed on the LEDs 11 and configured to diffuse the light emitted from the LEDs 11 and light reflected from the reflector 12. The LCD panel 2 is disposed on the diffuser 13 and configured to display images.

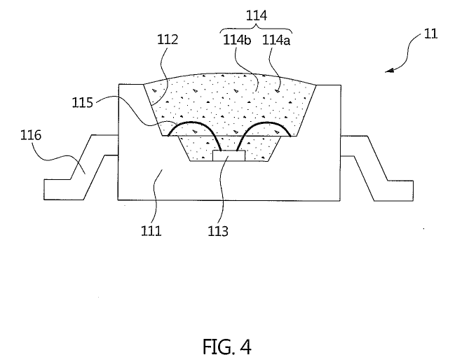

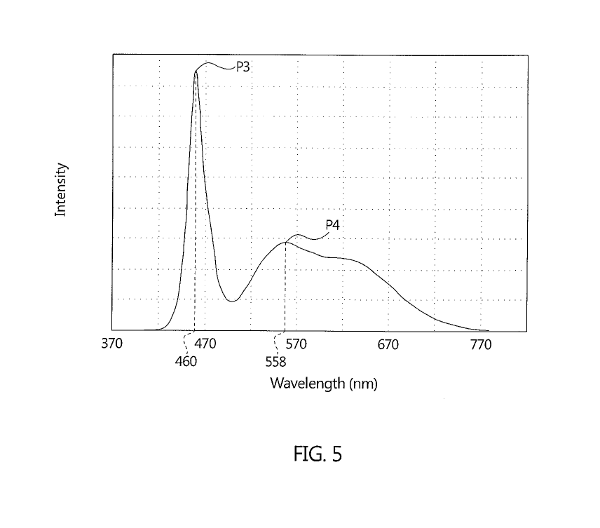

Each of the LEDs 11 may be a white LED. Referring to FIGS. 4 and 5, there are provided schematic diagrams showing a cross-sectional view and a spectrum of a white LED respectively, according to an exemplary embodiment of the present invention. The white LED 11 of this embodiment includes a base 111, a concave space 112 formed on the base 111, a blue LED die 113 disposed on a bottom of the concave space 112, and a phosphor layer 114 formed on the blue LED die 113 and filled in the concave space 112. A mixture of phosphor particles 114a and a resin 114b is hardened into the transparent phosphor layer 114, in which the phosphor particles 114a are yellow phosphor particles.

The blue LED die 113 is, via metal leads 115, electrically connected to metal pins 116 disposed at sides of the base 111. By soldering the metal pins 116 to a circuit board (not shown), the blue LED die 113 may be electrically connected to an LED driving circuit (not shown) disposed on the circuit board. When the blue LED die 113 is driven by the LED driving circuit, it emits blue light with a peak wavelength of 460 nm. The phosphor particles 114a of the phosphor layer 114 absorb a portion of blue light emitted from the blue LED die 113 and are excited to emit yellow light. The yellow light are then mixed with another portion of blue light emitted from the blue LED die 113 and passing through the resin 114b to generate two-wavelength white light.

As shown in FIG. 5, the spectrum of the white LED 11 has two peaks P3 and P4 at two wavelengths of 460 nm and 558 nm respectively. The peak P3 with a stronger intensity is generated by the blue LED die 113 with a peak wavelength of 460 nm, and the peak P4 is generated by the phosphor layer 114. Because the peak wavelength of the light emitted from the blue LED die 113 of the white LED 11 of this embodiment is shifted to be 460 nm in place of prior 444 nm, the present invention may efficiently reduce blue light with wavelengths less than 455 nm, especially for wavelengths ranging from 415 to 455 nm (i.e. short-wavelength blue light), to reduce short-wavelength blue light causing damage to retinal cells to protect eyes. The present invention may not use materials capable of absorbing or reflecting blue light to realize the anti-blue-light function, and therefore may not reduce display brightness and encounter color aberration.

Although the white LED 11 of this embodiment uses the blue LED die 113 with a peak wavelength of 460 nm, it is not intended to limit the scope of the present invention. For example, the white LED may change to use a blue LED die with any peak wavelength ranging from 455 to 475 nm, or even from 460 to 470 nm. For example, the white LED may be replace by a blue LED, and the blue LED uses a blue LED die with any peak wavelength ranging from 455 to 475 nm, or even from 460 to 470 nm. For example, the phosphor layer including the yellow phosphor particles may further include other type of phosphor particles (such as red and/or green phosphor particles), so the yellow phosphor particles and other type of phosphor particles form composite phosphor particles. The composite phosphor particles absorb blue light and are excited to emit yellow light and other type of light (such as red and/or green light) to mix with the blue light to generate specific light (such as three-wavelength white light, or other colored light).

Moreover, the present invention may further use an optical filter sheet or film made of materials capable of absorbing or reflecting blue light to filter blue light with wavelengths less than 455 nm, so that the present invention may further reduce blue light with wavelengths less than 455 nm while not blocking blue light with wavelengths larger than 455 nm too much, and therefore may modulate reduced display brightness and reduce color aberration.

In an embodiment, the direct-lit backlight module 1 further includes one or more optical filter sheets configured to filter blue light with wavelengths less than 455 nm. Each optical filter sheet is disposed between the LEDs 11 and the diffuser 13, or between the diffuser 13 and the LCD panel 2, or on the LCD panel 2, as shown in FIG. 3.

In another embodiment, the direct-lit backlight module 1 further includes one or more optical filter films configured to filter blue light with wavelengths less than 455 nm. Each optical filter film is disposed on the phosphor layer 114 of each of the LEDs 11 as shown in FIG. 4. Or, each optical filter film is disposed on the diffuser 13, or on the LCD panel 2, as shown in FIG. 3.

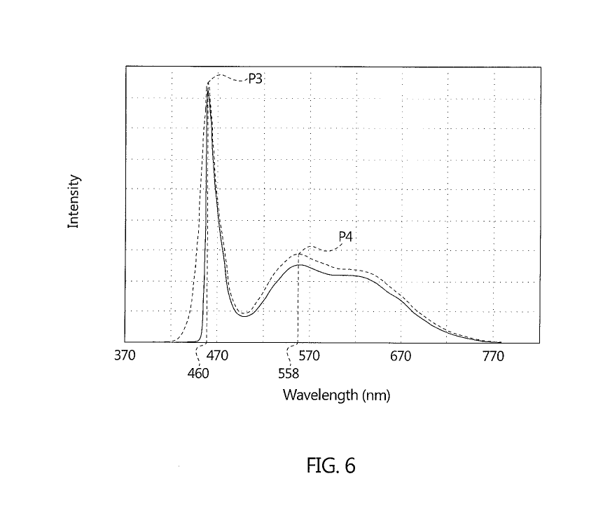

Referring to FIG. 6, there is provided a schematic diagram showing a spectrum of a white LED according to another exemplary embodiment of the present invention. The white LED of this embodiment is the white LED 11, as shown in FIG. 4, further including an optical filter film disposed on the phosphor layer 114 of the white LED 11. As shown in FIG. 6, the optical filter film may further reduce blue light with wavelengths less than 455 nm while not blocking blue light with wavelengths larger than 455 nm too much.

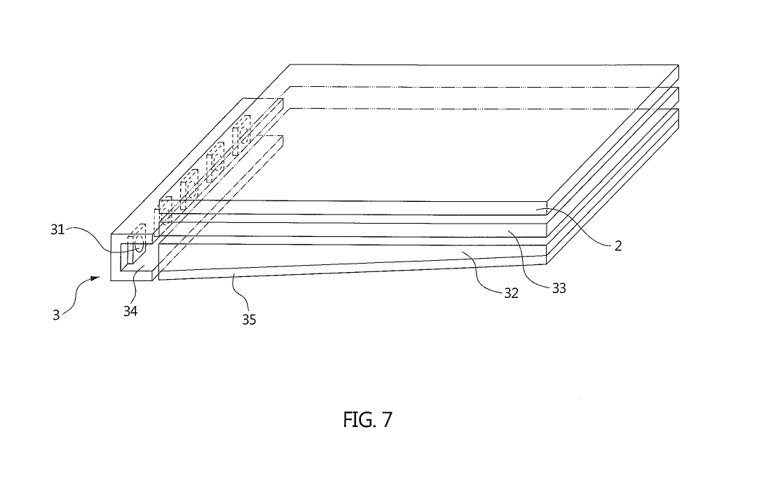

Referring to FIG. 7, there is provided a schematic diagram showing a perspective view of a display panel using an edge-lit backlight module according to an exemplary embodiment of the present invention. The display panel of this embodiment includes an edge-lit backlight module 3 and an LCD panel 2. The edge-lit backlight module 3 includes a plurality of LEDs 31, a light guide plate 32 and a diffuser 33. The LEDs 31 are disposed at a side of the light guide plate 32. The light guide plate 32 is configured to guide the light emitted from the LEDs 31 toward the diffuser 33. The diffuser 33 is disposed on the light guide plate 32 and configured to diffuse light outputted from the light guide plate 32. The LCD 2 panel is disposed on the diffuser 33 and configured to display images.

The edge-lit backlight module 3 further includes reflectors 34 and 35. The reflector 34 is disposed around the LEDs 31 and configured to reflect the light emitted from the LEDs 31, and therefore the side of the light guide plate 32 may receive not only the light emitted from the LEDs 31 but also light reflected from the reflector 34. The reflector 35 is disposed under the light guide plate 32 and configured to reflect the light guided in the light guide plate 32 toward the diffuser 33.

In this embodiment, each of the LEDs 31 is a white LED 11 as shown in FIG. 4. Because the peak wavelength of the light emitted from the blue LED die 113 of the white LED 31 (i.e. the white LED 11) of this embodiment is shifted to be 460 nm in place of prior 444 nm, the present invention may efficiently reduce blue light with wavelengths less than 455 nm, especially for wavelengths ranging from 415 to 455 nm (i.e. short-wavelength blue light), to reduce short-wavelength blue light causing damage to retinal cells to protect eyes. The present invention may not use materials capable of absorbing or reflecting blue light to realize the anti-blue-light function, and therefore may not reduce display brightness and encounter color aberration.

Although the white LED 31 (i.e. the white LED 11) of this embodiment uses the blue LED die 113 with a peak wavelength of 460 nm, it is not intended to limit the scope of the present invention. For example, the white LED may change to use a blue LED die with any peak wavelength ranging from 455 to 475 nm, or even from 460 to 470 nm. For example, the white LED may be replace by a blue LED, and the blue LED uses a blue LED die with any peak wavelength ranging from 455 to 475 nm, or even from 460 to 470 nm.

Moreover, the present invention may further use an optical filter sheet or film made of materials capable of absorbing or reflecting blue light to filter blue light with wavelengths less than 455 nm, so that the present invention may further reduce blue light with wavelengths less than 455 nm while not blocking blue light with wavelengths larger than 455 nm too much, and therefore may modulate reduced display brightness and reduce color aberration.

In an embodiment, the edge-lit backlight module 3 further includes one or more optical filter sheets configured to filter blue light with wavelengths less than 455 nm. Each optical filter sheet is disposed between the LEDs 31 and the side of the light guide plate 32, or between the light guide plate 32 and the diffuser 33, or between the diffuser 33 and the LCD panel 2, or on the LCD panel 2, as shown in FIG. 7.

In another embodiment, the edge-lit backlight module 3 further includes one or more optical filter films configured to filter blue light with wavelengths less than 455 nm. Each optical filter film is disposed on the phosphor layer 114 of each of the LEDs 11 as shown in FIG. 4. Or, each optical filter film is disposed on the side of the light guide plate 32 corresponding to the LEDs 31, or on another side of the light guide plate 32 corresponding to the diffuser 33, or on the diffuser 33, or on the LCD panel 2, as shown in FIG. 7.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A display panel with reduced short-wavelength blue light, comprising a backlight module and a liquid-crystal display (LCD) panel, wherein the backlight module comprises a plurality of light-emitting diodes (LEDs), wherein each of the LEDs comprises a blue LED die configured to emit blue light with a peak wavelength ranging from 455 to 475 nm.

2. The display panel of claim 1, wherein the backlight module comprises a direct-lit backlight module.

3. The display panel of claim 2, wherein the direct-lit backlight module further comprises a reflector and a diffuser, wherein the reflector is disposed under the LEDs and configured to reflect light emitted from the LEDs, wherein the diffuser is disposed on the LEDs and configured to diffuse the light emitted from the LEDs and light reflected from the reflector, wherein the LCD panel is disposed on the diffuser and configured to display images.

4. The display panel of claim 3, wherein the direct-lit backlight module further comprises an optical filter sheet, wherein the optical filter sheet is disposed between the LEDs and the diffuser, or between the diffuser and the LCD panel, or on the LCD panel, and configured to filter blue light with wavelengths less than 455 nm.

5. The display panel of claim 3, wherein the direct-lit backlight module further comprises an optical filter film, wherein the optical filter film is disposed on each of the LEDs, or on the diffuser, or on the LCD panel, and configured to filter blue light with wavelengths less than 455 nm.

6. The display panel of claim 1, wherein the backlight module comprises an edge-lit backlight module.

7. The display panel of claim 6, wherein the edge-lit backlight module further comprises a light guide plate and a diffuser, wherein the LEDs are disposed at a side of the light guide plate, wherein the light guide plate is configured to guide the light emitted from the LEDs toward the diffuser, wherein the diffuser is disposed on the light guide plate and configured to diffuse light outputted from the light guide plate, wherein the LCD panel is disposed on the diffuser and configured to display images.

8. The display panel of claim 7, wherein the edge-lit backlight module further comprises an optical filter sheet, wherein the optical filter sheet is disposed between the LEDs and the side of the light guide plate, or between the light guide plate and the diffuser, or between the diffuser and the LCD panel, or on the LCD panel, and configured to filter blue light with wavelengths less than 455 nm.

9. The display panel of claim 7, wherein the edge-lit backlight module further comprises an optical filter film, wherein the optical filter film is disposed on each of the LEDs, or on the side of the light guide plate corresponding to the LEDs, or on another side of the light guide plate corresponding to the diffuser, or on the diffuser, or on the LCD panel, and configured to filter blue light with wavelengths less than 455 nm.

10. The display panel of claim 1, wherein each of the LEDs further comprises a phosphor layer, wherein the phosphor layer is formed around the blue LED die and configured to be excited to emit light to mix with the blue light emitted from the blue LED die to generate specific light.

11. The display panel of claim 10, wherein the backlight module comprises a direct-lit backlight module.

12. The display panel of claim 11, wherein the direct-lit backlight module further comprises a reflector and a diffuser, wherein the reflector is disposed under the LEDs and configured to reflect light emitted from the LEDs, wherein the diffuser is disposed on the LEDs and configured to diffuse the light emitted from the LEDs and light reflected from the reflector, wherein the LCD panel is disposed on the diffuser and configured to display images.

13. The display panel of claim 12, wherein the direct-lit backlight module further comprises an optical filter sheet, wherein the optical filter sheet is disposed between the LEDs and the diffuser, or between the diffuser and the LCD panel, or on the LCD panel, and configured to filter blue light with wavelengths less than 455 nm.

14. The display panel of claim 12, wherein the direct-lit backlight module further comprises an optical filter film, wherein the optical filter film is disposed on each of the LEDs, or on the diffuser, or on the LCD panel, and configured to filter blue light with wavelengths less than 455 nm.

15. The display panel of claim 10, wherein the backlight module comprises an edge-lit backlight module.

16. The display panel of claim 15, wherein the edge-lit backlight module further comprises a light guide plate and a diffuser, wherein the LEDs are disposed at a side of the light guide plate, wherein the light guide plate is configured to guide the light emitted from the LEDs toward the diffuser, wherein the diffuser is disposed on the light guide plate and configured to diffuse light outputted from the light guide plate, wherein the LCD panel is disposed on the diffuser and configured to display images.

17. The display panel of claim 16, wherein the edge-lit backlight module further comprises an optical filter sheet, wherein the optical filter sheet is disposed between the LEDs and the side of the light guide plate, or between the light guide plate and the diffuser, or between the diffuser and the LCD panel, or on the LCD panel, and configured to filter blue light with wavelengths less than 455 nm.

18. The display panel of claim 16, wherein the edge-lit backlight module further comprises an optical filter film, wherein the optical filter film is disposed on each of the LEDs, or on the side of the light guide plate corresponding to the LEDs, or on another side of the light guide plate corresponding to the diffuser, or on the diffuser, or on the LCD panel, and configured to filter blue light with wavelengths less than 455 nm.
